(19) United States
(12) Patent Application Publication
(10) Pub. No.: US 2003/0011647 A1
(43) Pub. Date: Jan. 16, 2003

(54) System and method for indicating a status of multiple features of a data processing system

(75) Inventors: Antonio Abbondanzio, Raleigh, NC (US); Alan Joseph Happ, Raleigh, NC (US); Gayle Colby Steinbugler, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/906,351

(22) Filed: Jul. 16, 2001

(51) Int. Cl. G06F 3/14

(52) U.S. Cl. 345/853

(57) ABSTRACT

A data processing system, which includes a processor and a memory, is equipped with a system resource monitor, executable by the processor and stored in the memory, that displays a multi-level tree structure in which each level includes a textual identification for a respective one of multiple features in the data processing system. The features are monitored by the system resource monitor for information regarding the status of the features. This information further indicates a normal status or a notification status. If the information indicates a normal status, a placeholder icon and the textual identification of the respective one of the multiple features is displayed. If the information indicates a notification status, the system resource monitor also displays a notification indicia.

### BACKGROUND OF THE INVENTION

1. Technical Field

The present invention relates in general to data processing systems, and more particularly, monitoring of data processing systems. Still more particularly, the present invention relates to a system and method for displaying the status of data processing system features.

2. Description of the Related Art

The tree structure view is an increasingly popular view of hierarchical relationships of data and/or features of a data processing system. For example, the Microsoft Windows™ 95/98/NT/2000/ME operating systems implement a system management interface and directory listings in a tree structure view.

In a system management interface 100, as depicted in FIG. 3A, hierarchical relationships are typically illustrated by depicting an icon 102 and a textual identification 104 that represents a root feature. A feature is herein defined as “a unique, attractive, or desirable property of a program or of a computer or other hardware.” Related and/or dependent features are depicted in a similar fashion, but are indented below the root feature. Icons 102 are generally redundant with the textual identification 104 and do not add additional information. Typically, icon 102 is colorful and detailed, which generally distracts the user from relevant information displayed in the tree structure.

Users (e.g., network administrators) frequently monitor the data processing system features for a change of states. System management interface 100 illustrated in FIG. 3A displays a graphical notification of a notification state to the user by simply adding a small overlay icon to icon 102. The small overlay icons must compete with the already cluttered system management interface to alert the user of a change of the state of a feature of the data processing system. The first overlay icon is a warning icon 106 that indicates that the specified feature has encountered a condition where a program error and/or hardware failure may occur, herein referred to as a “warning status.” The second overlay icon is an error icon 108 that indicates that the specified feature has encountered a program error and/or hardware failure, herein referred to as an “error status.”

The cluttered system management interface requires tedious visual discrimination between highly similar icons to detect a change in operating conditions. Consequently, it would be desirable to provide an improved system and method for indicating the status of multiple features in a data processing system.

### SUMMARY OF THE INVENTION

To overcome the foregoing and additional limitations in the prior art, the present invention provides an improved data processing system and method for indicating the status of multiple features within the data processing system. The data processing system includes a processor, a memory, and a system resource monitor stored in the memory and executable by the processor.

The system resource monitor displays a multi-level tree structure where each level includes a textual identification of a respective one of multiple features in the data processing system. The features are monitored by the system resource monitor for information regarding the status of the features. A textual identification of the respective one of the multiple features and a placeholder icon is displayed if the information indicates a normal status. If the information indicates a notification status (e.g., any status that requires a user to be notified), the system resource monitor displays one of various graphically distinct notification indicia in place of the placeholder icon.

### DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of an exemplary data processing system, which may be utilized to implement the present invention;

FIG. 2 illustrates a layer diagram of the software utilized to implement a preferred embodiment of the present invention;

FIG. 3A depicts a graphical user interface (GUI) of a system manager according to the prior art;

FIG. 3B illustrates a graphical user interface (GUI) of a system resource monitor in accordance with a preferred embodiment of the present invention; and

FIG. 4 depicts a high-level logic flowchart of a method of indicating a status of a respective one of a plurality of features within a data processing system to a user in accordance with a preferred embodiment of the present invention.

### DESCRIPTION OF THE PREFERRED EMBODIMENT

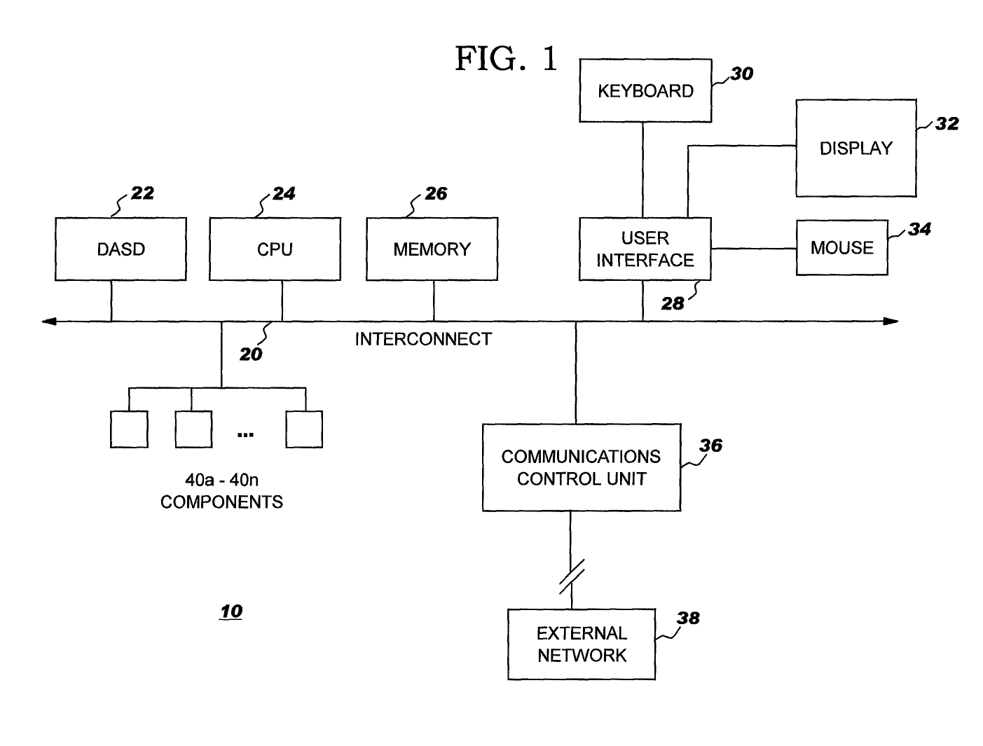

With reference now to the figures and in particular with reference to FIG. 1, there is depicted a detailed block diagram of a data processing system 10 in which a preferred embodiment of the present invention may be implemented. As illustrated, data processing system 10 includes a DASD 22, CPU 24, memory 26, user interface 28, communication control unit 36, and multiple components 40a-40n coupled by a system interconnect 20. It should be readily apparent to those skilled in the art that system interconnect 20 may be implemented as one or more buses, switches or any other type of coupling apparatus. Central processing unit (CPU) 24, which may be implemented as one or more processors, such as any generation of Pentium™ processor available from Intel Corporation in Santa Clara, Calif., executes software instructions to control the operation of data processing system 10.

Memory 26 provides storage for software and data and may include both read-only memory (ROM) and random access memory (RAM). Direct access storage device (DASD) 22 provides additional non-volatile storage for data processing system 10. DASD 22 may include, for example, a CD-ROM, a CD-RW, a DVD disk drive, a hard disk drive, and/or a floppy disk drive.

User interface 28 provides an interface between data processing system 10 and peripherals employed by a user to interact with data processing system 10. User interface 28 may include various adapters and drivers for controlling peripherals, such as keyboard 30, display 32, and mouse 34. Communications control unit 36 provides an interface between data processing system 10 and an external network 38, which may be a local area network (LAN) or a wide area network (WAN) such as the Internet. Components 40a-40n can be any type of peripheral, such as additional controller cards or adapters.

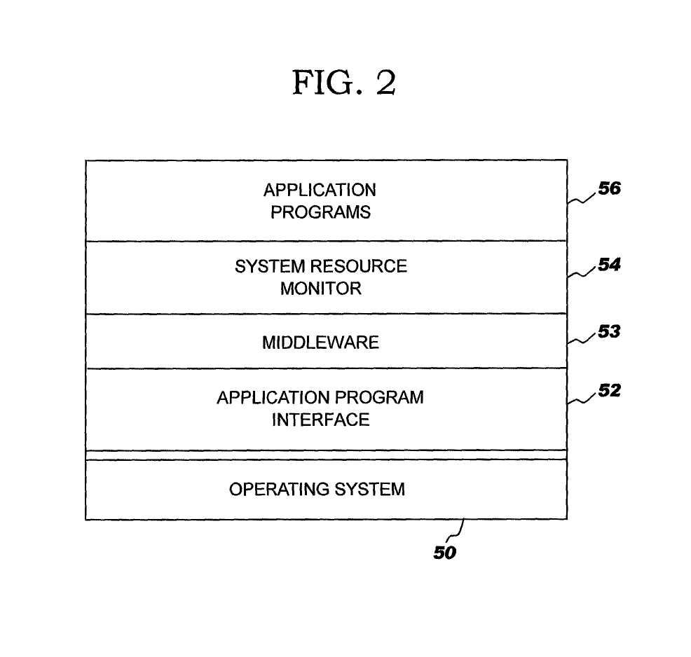

Referring to now FIG. 2, an exemplary layer diagram of the software configuration of data processing system 10 is illustrated. As well known in the art, a data processing system requires a set of program instructions, known as an operating system, to function properly. Basic functions (e.g., saving data to a memory device or controlling the input and output of data by the user) are handled by operating system 50, which may be at least partially stored in memory 26 and/or DASD 22 of data processing system 10. A set of application programs 56 for user functions (e.g., e-mail programs, word processors, Internet browsers), runs on top of operating system 50. As shown, system resource monitor 54 and application programs 56 access the functionality of operating system 50 via an application program interface 52. Alternatively, system resource monitor 54 can be implemented as part of operating system 50, or as middleware 53.

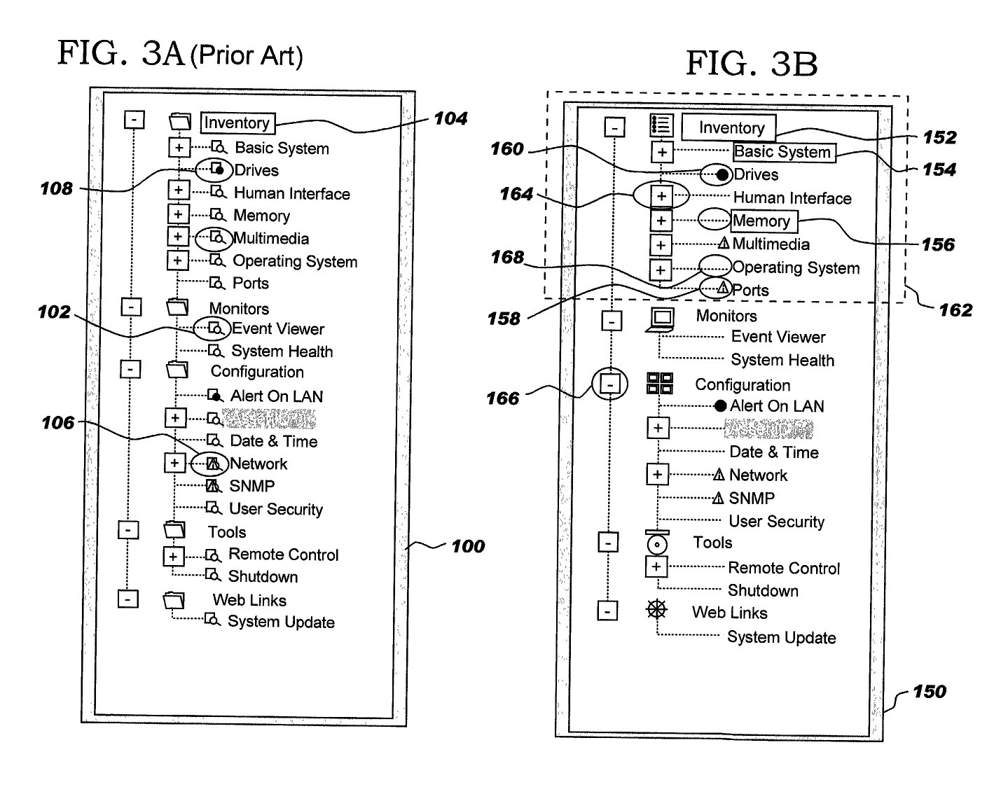

With reference to FIG. 3B, there is depicted a graphical user interface (GUI) of system resource monitor 54, herein referred to as system resource monitor interface 150. As shown, multiple features of data processing system 10 are organized in a multi-level tree structure 162. For example, CPU 24, user interface 28, and components 40a-40n are considered hardware features, while operating system 50 and application programs 56 are examples of software features. Multi-level tree structure 162 is a data structure including one or more nodes that are linked together in a hierarchical fashion. A root node, or the base of multi-level tree structure 162, can have related child nodes. By selecting a first expansion block 164 displaying a “+” sign next to a root node in system resource monitor interface 150 utilizing mouse 34, the user invokes display of all related child nodes. However, if a second expansion block 166 displaying a “−” sign next to a root node is selected by the user utilizing mouse 34, all child nodes related to the root node are hidden from the user to present a simplified view of multi-level tree structure 162.

Features of the data processing system are monitored by system resource monitor 54 for one of two states: a normal status or a problem status. Features such as “Inventory” 152, herein referred to as “root features,” occupy the top of a multi-level tree structure 162. Indented below and related to the independent features are “child features,” such as “basic system” 154. System resource monitor interface 150 displays a placeholder icon 168 and a textual identification 156 of a feature if system resource monitor 54 observes a normal status from the feature. However, if system resource monitor 54 observes a notification status from the feature, various graphically distinct indicia are displayed next to textual identification 156 of the feature by system resource monitor interface 150, depending on the type of notification status. Notification indicia 158 and 160 are graphical icons implemented as bitmaps.

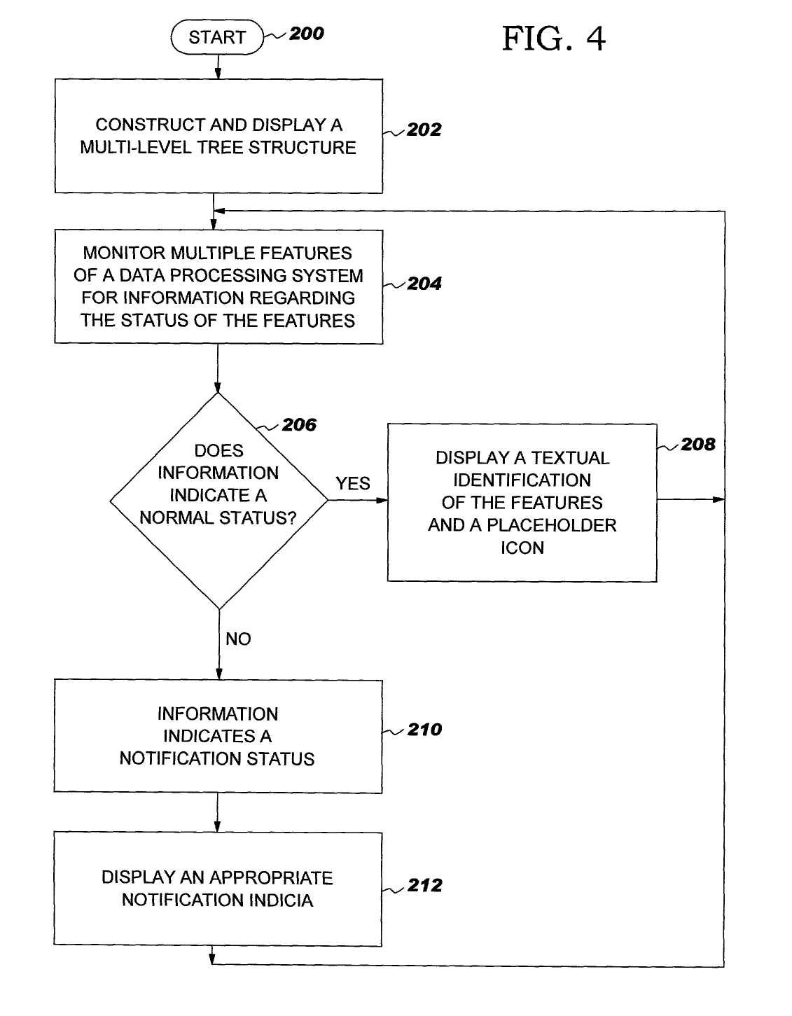

Referring now to FIG. 4, a high-level logic flowchart depicting a preferred method of indicating to a user the status of multiple features within a data processing system is illustrated. A preferred embodiment of the present invention can implement the feature status indication method utilizing a system resource monitor 54 stored in memory 26 and executable by CPU 24 of data processing system 10. The preferred method of indicating a status of multiple features results in the display of a multi-level tree structure including indications regarding the status of the components in the data processing system.

The process begins as illustrated in block 200 and continues to block 202, which depicts the display of a multi-level tree structure. Each level of the multi-level tree structure includes a textual identification for a respective one of multiple features within data processing system 10. Next, the process enters a monitoring loop including blocks 204-212. As depicted in block 204, a system resource monitor observes the multiple features within data processing system 10 for information regarding a status of one of the multiple features.

If the information indicates a normal status, as illustrated in block 206, the process continues to block 208, which depicts the system resource monitor displaying the textual identification of the feature and a placeholder icon in the multi-level tree structure. The process returns to block 204 from block 208. If, as illustrated in block 210, the information indicates a notification status, the process continues to block 212. If the problem status indicates a notification status, as depicted in block 210, the system resource monitor displays one of various graphically distinct indicia next to the textual identification of the feature in the multi-level tree structure, as shown in block 212. The process returns to block 204 from block 212.

By displaying a textual identification and a placeholder icon when the system resource monitor observes a normal status, a user determines, even from a substantial distance, that the respective feature is functioning normally because the feature clearly does not have a graphical indicator of a notification status.

As described above, an improved system and method for indicating a status of multiple features within a data processing system to a user is presented. An exemplary data processing system, as implemented according to a preferred embodiment of the present invention, includes a system resource monitor, stored in a memory and executable by a processor. The system resource monitor observes the status of the features and displays various graphically distinct indicia on the system resource monitor interface depending on the status of the features. The user can clearly ascertain the status of multiple features of a data processing system because the system resource monitor displays a textual identification of the feature and a placeholder icon if the feature is functioning normally. When the system resource monitor observes a notification status for a feature, various graphically distinct indicia is displayed adjacent the textual identification of the feature by the system resource monitor.

Although aspects of the present invention have been described with respect to a computer system executing software that directs the functions of the present invention, it should be understood that present invention may alternatively be implemented as a program product for use with a data processing system. Programs defining the functions of the present invention can be delivered to a data processing system via a variety of signal-bearing media, which include, without limitation, non-rewritable storage media (e.g., CD-ROM), rewritable storage media (e.g., a floppy diskette or hard disk drive), and communication media, such as digital and analog networks. It should be understood, therefore, that such signal-bearing media, when carrying or encoding computer readable instructions that direct the functions of the present invention, represent alternative embodiments of the present invention.

While the invention has been particularly shown and described with reference to a preferred embodiment, it will also be understood by those skilled in the art that various changes in form and detail may be made therein without departing from the spirit and scope of the invention.

What is claimed is:

1. A method of indicating a status of a plurality of features of a data processing system to a user, said method comprising:
displaying a graphical multi-level tree structure, wherein each level in said tree structure includes a textual identification for a respective one of said plurality of features;
monitoring said plurality of features for information regarding said status of said plurality of features;
determining if said information indicates a normal status or a notification status; and
for each of said plurality of features, displaying said textual identification of said respective one of said plurality of features and a placeholder icon adjacent to said textual identification, in response to determining said information indicates said normal status and displaying a notification indicia adjacent to said textual identification in said multi-level tree structure, in response to determining said information indicates said notification status.

2. The method of claim 1, wherein said step of determining further includes:
determining the nature of said notification status.

3. The method of indicating a status of a plurality of features of a data processing system to a user according to claim 2, said step of displaying a notification indicia further comprising:
displaying an appropriate graphically distinct notification indicia in said multi-level tree structure, in response to determining the nature of said notification status.

4. A data processing system, comprising:
a processor;
a user interface coupled to said processor, said user interface including a display; and
a memory coupled to said processor, said memory including:
a system resource monitor executable by said processor, wherein said system resource monitor displays to a user on said display a multi-level tree structure including a textual identification of a plurality of features of said data gas. processing system and indicates a status of said plurality of features by displaying said textual identification and a placeholder icon for features having a normal status and displaying a notification indicia for features having a notification status.

5. The data processing system according to claim 4, wherein said system resource monitor determines the nature of said notification status.

6. The data processing system according to claim 5, wherein said system resource monitor displays a graphically distinct notification indicia, in response to determining the nature of said notification status.

7. A computer program product, comprising:
a computer-usable medium; and
a system resource monitor encoded within said computer-usable medium, wherein said system resource monitor displays to a user on said display a multi-level tree structure including a textual identification of a plurality of features of said data processing system and indicates a status of said plurality of features by displaying a placeholder icon adjacent to said textual identification for features having a normal status and displaying a notification indicia for features having a notification status.

8. The computer program product according to claim 7, wherein said system resource monitor determines the nature of said notification status.

9. The computer program product according to claim 8, wherein said system resource monitor displays a graphically distinct notification indicia, in response to determining the nature of said notification status.
